(19) United States
(12) Patent Application Publication
(10) Pub. No.: US 2004/0156705 A1
(43) Pub. Date: Aug. 12, 2004

(54) Unitary lift gate

(76) Inventors: Karapet Ablabutyan, Glendale, CA (US); Paul Bark, Canyon Lake, CA (US)

Correspondence Address: Robert D. Becker, Manatt Phelps and Phillips, Building 2, 1001 Page Mill Road, Palo Alto, CA, 94304, US

(21) Appl. No.: 10/714,826

(22) Filed: Nov. 14, 2003

Related U.S. Application Data
(63) Continuation-in-part of application No. 09/811,237, filed on Mar. 15, 2001.

(51) Int. Cl. B60P 1/00

(52) U.S. Cl. 414/557

(57) ABSTRACT

A unitary cantilever lift gate (10) includes a unitary frame (12) and a lift frame (21). The lift gate (10) may be fully assembled and tested prior to installation on a vehicle (60). Various features such as steps (51), dock bumpers (56), and vehicle light brackets (58) are integrated into the unitary frame (12). A pair of frame adapters (71) attach the unitary frame (12) to the vehicle (60). The frame adapters (71) have slots (75) to allow an adjustment of the lift gate (10) relative to the vehicle (60). Furthermore, the lift gate (10) is configured so that multiple units can be stacked together for shipping and ease of unloading and loading.

This is a continuation-in-part of U.S. patent application Ser. No. 09/811,237 filed on Mar. 15, 2001.

### FIELD OF THE INVENTION

The present invention generally relates to an apparatus for carrying loads between two levels and in particular relates to a lift gate for lifting and lowering loads between ground level and the payload level of a vehicle.

### BACKGROUND OF THE INVENTION

Lift gates are typically mounted at the rear of trucks, truck trailers and the like to bring payloads from ground level up to the truck bed or from the truck bed to the ground. In some applications, it is desirable to configure the lift gate so that it folds away when not in use. Examples of such designs are the cantilever Tuk-A-Way® lift gates available from Maxon Lift Corporation (11921 Slauson Avenue, Santa Fe Springs, Calif. 90670). Typically, these lift gates employ parallelogram linkages to maintain the lift gate in a horizontal plane through the lifting range. The lift gate is attached to the parallelogram linkages by pivot members, which allow the lift gate to be placed in a generally vertical position when in the lowered position. When in the vertical position, operation of the lifting mechanism rotates the lift gate into an inverted, stowed position beneath the vehicle body.

Prior art Tuk type cantilever lift gates present various challenges having to do with their shipping and installation. All prior art Tuk type cantilever lift gates mount to the vehicle chassis. Thus, these lift gates are susceptible to misalignment with the vehicle body. When misaligned, operation of the lift gate can exert differential force on the vehicle body, tending to separate them. Further, typical cantilever lift gates, when shipped from the factory, are partially disassembled and have awkward shapes, requiring substantial packaging. Further, proper installation necessitates that several of the components must be precisely aligned and then securely mounted to the vehicle. Moreover, the lift gate must be fitted to the vehicle only after the vehicle body has been attached to the chassis. Consequently, proper installation of prior art lift gates involve significant time and expense.

Furthermore, in prior art lift gate designs, lift platforms may become misaligned with the vehicle body. When the misalignment becomes severe, operation of the lift gate can exert a differential force on the vehicle body, causing it to separate from the vehicle chassis.

Accordingly, it would be advantageous to have an apparatus for lifting loads that is convenient and simple for shipping and installation. It would also be advantageous for the apparatus to have high overall strength and reliability. It would be of further advantage for the apparatus to be easily adaptable for various vehicle configurations.

### BRIEF DESCRIPTION OF THE DRAWINGS

FIG. 1 is a perspective view illustrating a unitary lift gate a stowed position in accordance with the present invention;

FIG. 2 is a perspective view illustrating the lift gate of FIG. 1 in a lowered position with a lift gate platform in a vertical orientation;

FIG. 3 is a side view illustrating the lift gate of FIG. 1 with the lift gate platform in the lowered position with the lift gate platform in a horizontal orientation;

FIG. 4 is a perspective view illustrating the lift gate of FIG. 1 in a raised position with the lift gate platform in the horizontal orientation;

FIG. 5 is a side view illustrating the lift gate of FIG. 1 in a raised position with the lift gate platform in the horizontal orientation;

FIG. 6 is a perspective view illustrating the lift gate of FIG. 1 secured to a portion of a vehicle body in accordance with the present invention; and

FIG. 7 is a perspective view illustrating a plurality of fully assembled unitary lift gates stacked together in accordance with the present invention; and

FIG. 8 is a perspective view of a frame adapter in accordance with the present invention.

### DETAILED DESCRIPTION OF VARIOUS EMBODIMENTS

Various embodiments of the present invention are described hereinafter with reference to the figures. Elements of like structures or function are represented with like reference numerals throughout the figures. The figures are only intended to facilitate the description of specific embodiments of the invention. They are not intended as an exhaustive description of the invention or as a limitation on the scope of the invention. In addition, an aspect described in conjunction with a particular embodiment of the present invention is not necessarily limited to that embodiment and can be practiced in conjunction with any other embodiments of the invention.

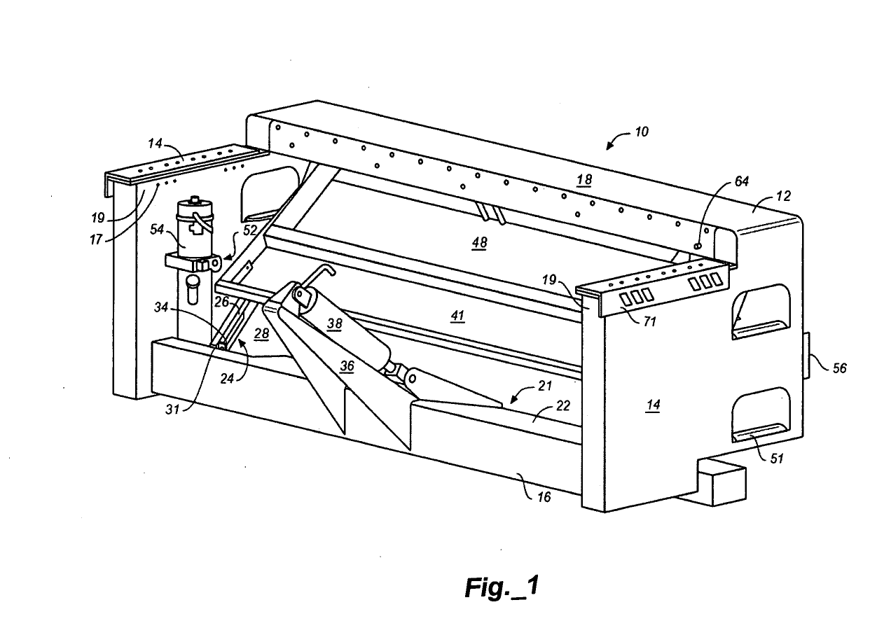

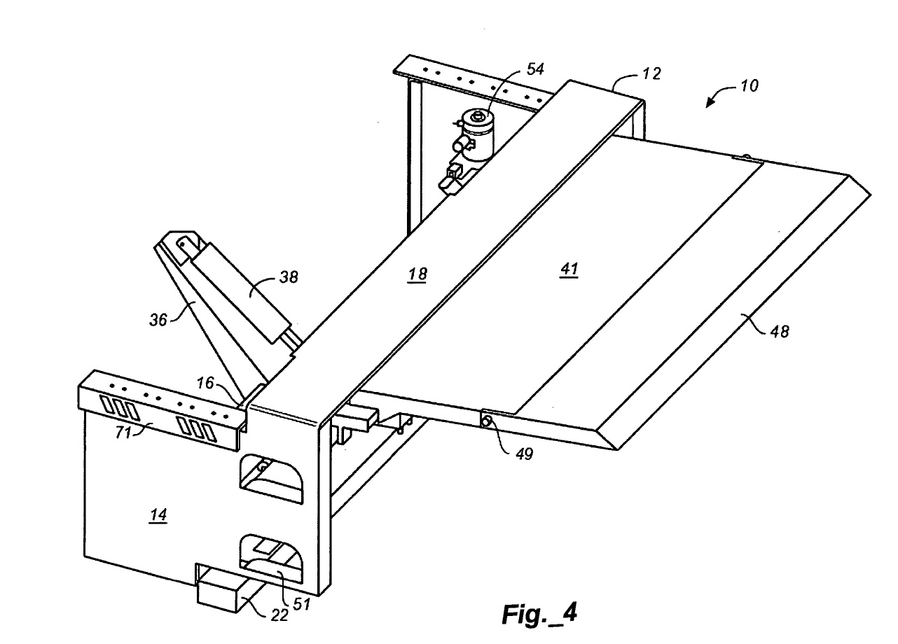

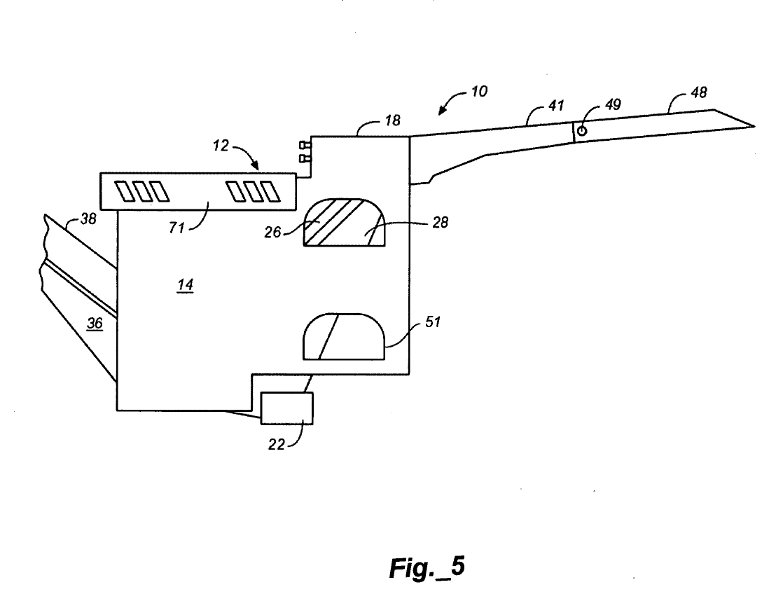

FIGS. 1-7 illustrate a unitary lift gate 10 in accordance with the present invention. Lift gate 10 is used for lifting loads between a low level, e.g., ground level, and a high level, e.g., a truck bed level. Lift gate 10 has a cantilever lifting mechanism. Accordingly, lift gate 10 is also referred to as a cantilever lift gate or simply a load lifting apparatus. The structural members of lift gate 10 are preferably formed from steel, but other metals or composite materials can be suitable depending upon the intended application.

Lift gate 10 includes a unitary frame 12 having an opposing pair of side plates 14. A trunnion bar 16 and an extension plate 18 extend between side plates 14. A plurality of holes or orifices 17 are formed in each of side plates 14 adjacent an upper edge 19 thereof.

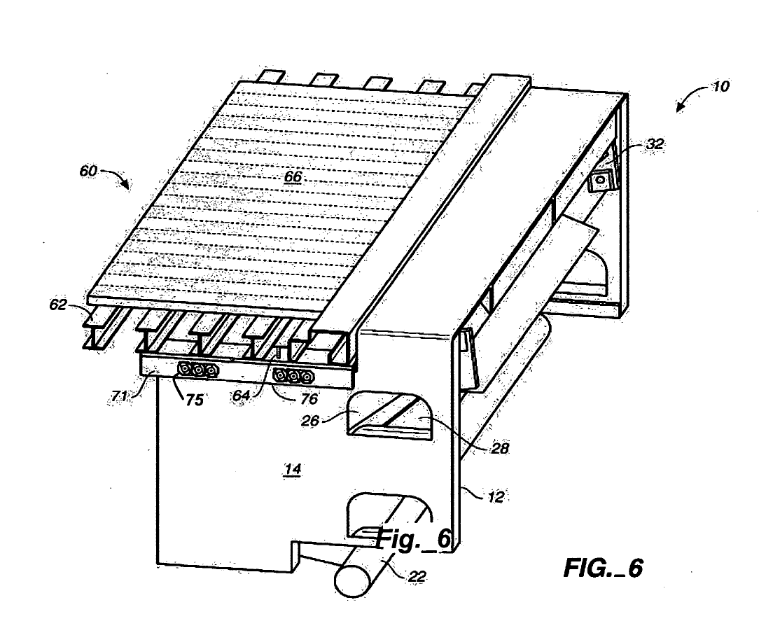

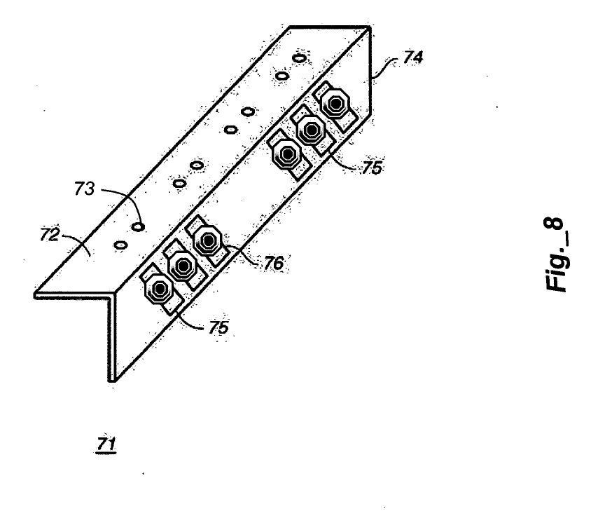

A pair of brackets or frame adapters 71 are removably attached to pair of side plates 14 near upper edges 19. Each of frame adapters 71 has two segments or sections. A perspective view of frame adapter 71 is shown in FIG. 8. A first section 72 is configured for attaching to a platform, e.g., a vehicle bed 66 as shown in FIG. 6. Holes 73 may be formed in first section 72 to attach frame adapter 71 to cross members 62 in vehicle bed 66 using bolts. First section 72 of frame adapter 71 can also be welded to vehicle bed 66. A second section 74 has a plurality of apertures 75 formed therein. Bolts 76 can be used to attach frame adapters 71 to side plates 14 through apertures 75 and orifices 17. In a preferred embodiment, apertures 75 are elongated slots that are oblique or perpendicular with respect to first section 72. Elongated slots allow the adjustment of the position of unitary frame 12 with respect to vehicle bed 66.

Lift gate 10 also includes a lift frame 21 that has a lift frame bar 22 extending between an opposing pair of parallelogram linkages 24. Each parallelogram linkage 24 includes an upper arm 26 and a lower arm 28, and a proximal pivot member 31 and a distal pivot member 32. Proximal pivot members 31 are attached to trunnion bar 16 thus securing lift frame 21 to unitary frame 12. Preferably, trunnion bar 16 comprises integral mounts 34 for attaching proximal pivot members 31.

A tower 36 is mounted on trunnion bar 16 of unitary frame 12. A hydraulic cylinder actuator 38 is pivotally attached at one end to tower 36 and at another end to lift frame bar 22. Tower 36 is also referred to as an actuator mount. A lift gate platform 41 is secured to distal pivot members 32 of parallelogram linkages 24. In operation, lift gate platform 41 carries the load. Lift gate platform 41 is also referred to as a load carrying plate. Hydraulic cylinder actuator 38 extends and retracts to raise and lower, respectively, lift gate platform 41 through lift frame 21. Parallelogram linkages 24 maintain the orientation of distal pivot members 32 with respect to proximal pivot members 31 as upper arms 26 and lower arms 28 are raised and lowered. Retraction of hydraulic cylinder actuator 38 drives lift frame bar 22, rotating upper arms 26 and lower arms 28 about proximal pivot members 31 to lower lift gate platform 41. Conversely, an extension of hydraulic cylinder actuator 38 raises lift frame bar 22.

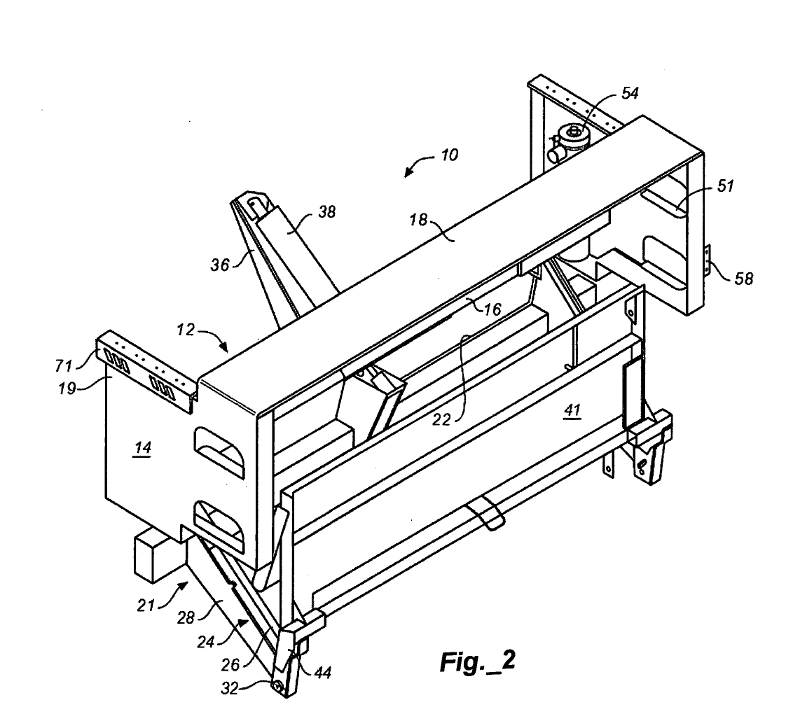

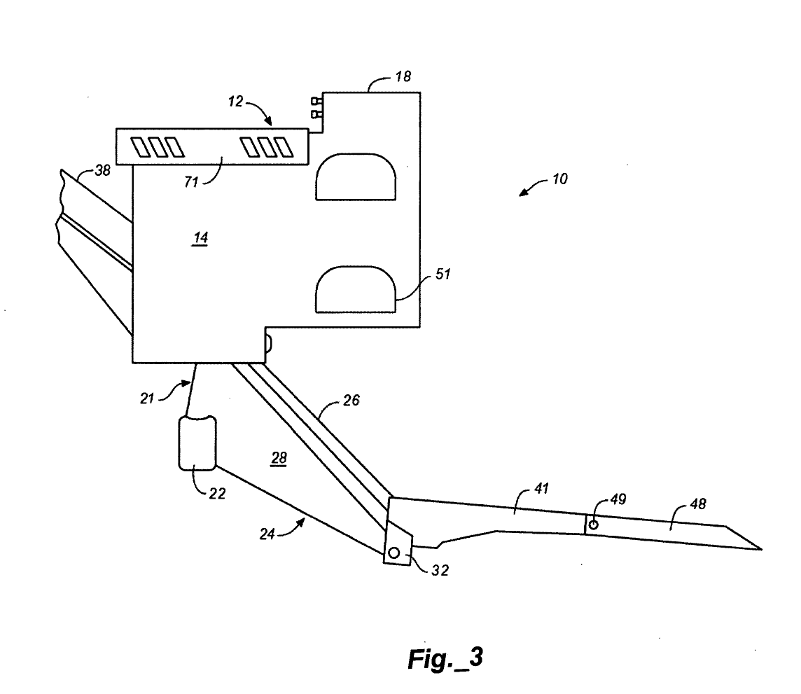

Lift gate platform 41 is rotatably attached to distal pivot members 32. Lift gate 10 is also referred to as a cantilever lift gate, wherein the term cantilever refers to lift gate 10 having lift gate platform 41 supported at one end only by the pivotal attachment to distal pivot members 32. Motion limiting tabs 44 are attached to lift frame 21 adjacent distal pivot members 32 to prevent a rotation of lift gate platform 41 away from upper and lower arms 26 and 28 beyond a horizontal orientation. This keeps lift gate platform 41 in a plane parallel with the ground and vehicle bed 66 of a vehicle 60 to facilitate loading and unloading, as shown in FIGS. 3, 4, and 5. On the other hand, lift gate platform 41 may be rotated at distal pivot members 32 toward upper and lower arms 26 and 28 to a generally vertical orientation as shown in FIG. 2. In this orientation, an extension of hydraulic cylinder actuator 38 raises and inverts lift gate platform 41 into a stowed position as shown in FIGS. 1 and 6.

In a preferred embodiment, lift gate platform 41 is equipped with a lift gate platform extension 48 attached by hinge 49, creating a bifold configuration. Hinge 49 allows lift gate platform extension 48 to fold against lift gate platform 41 toward parallelogram linkages 24, and prevents lift gate platform extension 48 from rotating away from parallelogram linkages 24 beyond the plane of lift gate platform 41. Lift gate platform extension 48 provides an increased load carrying area. When lift gate platform 41 is placed into the vertical position shown in FIG. 2, lift gate platform extension 48 folds back against lift gate platform 41, thereby providing a compact profile for storage. In other embodiments, more additional platform extensions may be provided creating a multiple fold configuration.

In accordance with various embodiments of the present invention, unitary frame 12 may include a variety of additional features to simplify the manufacture and to increase the utility of lift gate 10. For example, side plates 14 may comprise formed steps 51, pump bracket 52 for mounting pump 54 to power hydraulic cylinder actuator 38, dock bumpers 56 and vehicle light brackets 58. These features are integral with the unitary frame 12. However, they can also be separate members that are suitably attached to unitary frame 12. In a preferred embodiment, lift frame bar 22 is configured to function as an underride guard to minimize injury in the event of a rear end collision. Integrating underride protection into the existing lift gate system removes the need for an additional, dedicated horizontal underride protection member.

FIG. 6 shows lift gate 10 attached to vehicle 60. In this arrangement, lift gate 10 carries loads between the ground level and vehicle bed 66 of vehicle 60. In accordance with a preferred embodiment of the present invention, frame adapters 71 are secured to cross members 62 at the underside of vehicle bed 66. In a preferred embodiment shown in FIG. 6, first sections 72 of frame adapters 71 are secured to vehicle bed 66 by bolts 64 through holes 73 therein. However, welding or other means of attachment can also be used. Frame adapters 71 securely attach unitary frame 12 of lift gate 10 to vehicle 60. Apertures 75 formed in second sections 74 of frame adapters 71 allow an adjustment of the position of unitary frame 12 with respect to vehicle 60. Preferably, elongated and oblique apertures 75 allow the position of unitary frame 12 to be adjusted so that extension plate 18 is substantially coplanar and flush with vehicle bed 66 of vehicle 60. Once a desired position is achieved, fastening devices, e.g., bolts 76, are tightened to secure lift gate 10 to vehicle 60.

In accordance with the present invention, all components in lift gate 10 are attached to unitary frame 12, only unitary frame 12 needs to be attached to vehicle 60 via frame adapters 71. No alignment or adjustment of the lifting mechanism is necessary. Further, the unitary construction of lift gate 10 allows it to be attached to a wide variety of truck types. Typically, the only adjustment necessary is to level extension plate 18 with vehicle bed 66. This is easily accomplished by adjusting unitary frame 12 with respect to frame adapters 71 as described above, thereby aligning extension plate 18 with vehicle bed 66. The present invention allows integrated lift gate 10 to be fully pre-assembled, requiring only final bolt-on attachment to a vehicle body with little or no adjustment.

The integrated, unitary and compact nature of lift gate 10 in accordance with the present invention also facilitates shipping, packaging and storing. Unitary frame 12 with lift gate platform 41 in the stowed position presents a compact, box-like profile that may be stored or shipped with virtually no packaging.

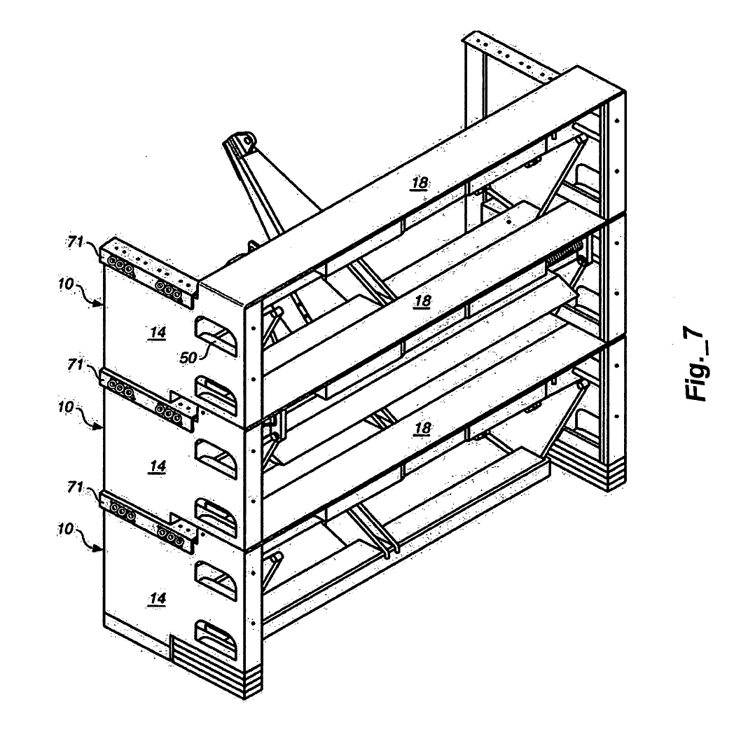

Further, multiple lift gates can be stacked and bolted together, as shown in FIG. 7, for shipment, thereby avoiding or minimizing the need to use pallets, banding material, or other packaging means. In one embodiment, the bottom profile of side plates 14 is configured to nest with the top profile of frame adapters 71 on the tops of side plates 14 and extension plate 18. This allows a stack of multiple lift gate units to be very stable and allows them to be easily secured together, by bolts or other suitable means. In another embodiment, frame adapters 71 are removed from unitary frame 12 when the multiple lift gates are stacked together. In this embodiment, the bottom profile of side plates 14 is configured to nest with the top profile of side plates 14 and extension plate 18.

Unitary cantilever lift gate 10 that attaches to the vehicle body rather than the vehicle chassis offers numerous benefits compared with prior art lift gate designs. First, lift gate 10 may be completely assembled and fully tested at the factory prior to being delivered for installment. This greatly improves quality control and simplifies installation. Lift gate 10 needs only be secured to the vehicle body by welding, bolting or other means, dramatically reducing the installation time required. Furthermore, because lift gate 10 is secured to vehicle 60, lift gate platform 41 will always be in alignment with vehicle bed 66. In prior art lift gate designs, lift platforms may become misaligned with the vehicle body. The operation of a severely misaligned lift gate may exert a differential force on the vehicle body, causing it to separate from the vehicle chassis. Lift gate 10 in accordance with the present invention completely avoids such problems.

By now it should be appreciated that a load lifting apparatus, i.e., a unitary lift gate, has been provided. The apparatus in accordance with the present invention is a pre-assembled, unitary Tuk type cantilever lift gate configured to be secured only to a platform, e.g., a vehicle body. The pre-assembled unitary lift gates may also be configured to allow multiple units to be stacked together to facilitate shipping and storage. The lift gate may be fully assembled and tested prior to being secured to the vehicle body. The features of the invention allow the lift gate to be installed and easily adjusted in significantly less time than any prior art cantilever lift gates.

While certain embodiments of the present invention are shown in the drawings and described above in detail, it should be understood that there is no intention to limit the invention to the specific form or forms disclosed. On the contrary, the intention is to cover all modifications, alternative constructions, and equivalents falling within the spirit and scope of the invention. The present invention is limited only by the claims that follow.

1. A load lifting apparatus for lifting a load to and from a platform, comprising:
a unitary frame including:
a first side plate and a second side plate, each having a plurality of orifices formed therein; and
an extension plate extending between said first side plate and said second side plate;
a lift frame pivotally attached to said first side plate and said second side plate and including:
a pivot member; and
a load carrying plate rotatably attached to said pivot member;
a first frame adapter and a second frame adapter, each including:
a first segment adapted for attaching to the platform; and
a second segment substantially perpendicular to said first segment and having a plurality of apertures formed therein; and
a plurality of fastening devices attaching said first frame adapter and said second frame adapter to respective said first side plate and said second side plate through said plurality of apertures and said plurality of orifices.

2. The load lifting apparatus of claim 1, further comprising a plurality of bolts bolting said first segment of said first frame adapter and said first segment of said second frame adapter to an underside of the platform.

3. The load lifting apparatus of claim 1, wherein:
said plurality of apertures in said second segment of said first frame adapter include a first plurality of elongated slots; and
said plurality of apertures in said second segment of said second frame adapter include a second plurality of elongated slots.

4. The load lifting apparatus of claim 3, wherein:
said first plurality of elongated slots are substantially parallel to each other; and
said second plurality of elongated slots are substantially parallel to each other.

5. The load lifting apparatus of claim 4, wherein:
said first plurality of elongated slots are oblique with respect to said first segment of said first frame adapter; and
said second plurality of elongated slots are oblique with respect to said first segment of said second frame adapter.

6. The load lifting apparatus of claim 1, further comprising a motion limiting device attached to said lift frame adjacent said pivot member and configured to limit a motion of said load carrying plate.

7. The load lifting apparatus of claim 1, further comprising a hydraulic actuator mounted on said unitary frame and coupled to said lift frame.

8. The load lifting apparatus of claim 1, further comprising an impact bumper attached to said unitary frame.

9. The load lifting apparatus of claim 1, wherein said lift frame further includes a lift frame bar configured to function as an underride guard.

10. The load lifting apparatus of claim 1, wherein said unitary frame further includes at least one upper stacking member and at least one lower stacking member, a profile of said lower stacking member being configured to nest with a profile of said upper stacking member.

11. A cantilever lift gate configured for lifting loads to a vehicle, comprising:
a unitary frame including an opposing pair of side plates and an extension plate extending there between, each of said opposing pair of side plates having a plurality of orifices formed therein adjacent an upper edge thereof;
an actuator driven lift frame pivotally attached to said pair of side plates and having a pivot member;
a lift gate platform attached to said pivot member; and
a pair of brackets, each including a first arm configured for attaching to a vehicle body and a second arm having a plurality of slots; and
a plurality of fastening devices coupling said pair of brackets to said opposing pair of side plates through said pluralities of slots and said pluralities of orifices.

12. The cantilever lift gate of claim 11, wherein said plurality of slots in said pair of brackets allow a position of said extension plate of said unitary frame to be adjusted relative to the vehicle body.

13. The cantilever lift gate of claim 12, wherein said extension plate of said unitary frame is adjusted to be substantially coplanar with a floor of the vehicle body.

14. The cantilever lift gate of claim 11, wherein said actuator driven lift frame is configured to be attached to said unitary frame prior to said pair of brackets being attached to the vehicle body.

15. The cantilever lift gate of claim 11, further comprising a motion limiting stop attached to said actuator driven lift frame adjacent said pivot member and configured to limit a rotational motion of the lift gate platform.

16. A lift gate for use with a vehicle having a vehicle bed, comprising:
a unitary frame including first and second side plates having a plurality of orifices formed therein, and a trunnion bar and an extension plate extending between said first and second side plates;
a lift frame including first and second parallelogram linkages, each having an upper arm, a lower arm, a distal pivot member, and a proximal pivot member secured to said trunnion bar, a lift frame bar extending between said lower arms, and a lift gate platform attached to said distal pivot members of said first and second parallelogram linkages;
an actuator pivotally secured to said trunnion bar and to said lift frame bar, an extension of said actuator raising said lift gate platform in a first orientation to a raised position substantially coplanar with said extension plate and inverting said lift gate platform in a second orientation into a stowed position;
first and second brackets, each including a first segment configured for attaching to an underside of the vehicle bed and a second segment having a plurality of slots formed therein; and
a plurality of fastening devices coupling said first and second brackets to respective said first and second side plates through said pluralities of slots and said pluralities of orifices.

17. The lift gate of claim 16, wherein said plurality of slots in said first and second brackets allow an adjustment of a position of said extension plate of said unitary frame relative to the vehicle bed.

18. The lift gate of claim 17, wherein:
said first segment of each of said first and second brackets is substantially perpendicular to said second segment thereof; and
said plurality of slots in said first and second brackets includes slots formed in said second segments and oblique with respect to said first segments.

19. The lift gate of claim 16, further comprising first and second motion restriction tabs mounted on said first and second parallelogram linkages adjacent said distal pivot members, said first and second motion restriction tabs preventing a rotation of said lift gate platform away from said upper and lower arms past the first orientation substantially parallel to said extension plate and allowing a rotation of said lift gate platform toward said upper and lower arms to the second orientation substantially perpendicular to said extension plate.

20. The lift gate of claim 16, wherein said actuator includes a hydraulic cylinder.

21. A method for providing a cantilever lift gate, comprising the steps of:
(a) providing a unitary frame comprising an opposing pair of side plates and an extension plate extending between the side plates;
(b) attaching a lift frame to the side plates;
(c) rotatably attaching a side of a lift gate platform to a pivot member of the lift frame; and
(d) attaching a pair of brackets to the opposing pair of side plates in the unitary frame using bolts through a plurality of apertures formed in the brackets and the side plates.

22. The method of claim 21, further comprising the step of attaching a motion limit member to the pivot member of the lift frame to confine a motion of the lift gate platform between a first orientation and a second orientation substantially perpendicular to each other.

23. The method of claim 21, further comprising, after completing steps (a), (b), (c), and (d), the steps of:
(e) securing the brackets to a vehicle body; and
(f) aligning the extension plate in the unitary frame to the vehicle body by adjusting an position of the apertures in the pair of side plates relative to the apertures in the pair of brackets.

24. The method of claim 23, further comprising, after completing steps (a), (b), (c), and (d), and before performing steps (e) and (f), the step of:
(g) stacking the cantilever lift gate on top of another cantilever lift gate.

25. The method of claim 24, further comprising, after completing steps (a), (b), (c), (d), and (g), and before performing steps (e) and (f), the step of:
(h) packaging and shipping the stacked cantilever lift gates together.
